(19) United States
(12) Patent Application Publication
(10) Pub. No.: US 2008/0148014 A1
(43) Pub. Date: Jun. 19, 2008

(54) METHOD AND SYSTEM FOR PROVIDING A RESPONSE TO A USER INSTRUCTION IN ACCORDANCE WITH A PROCESS SPECIFIED IN A HIGH LEVEL SERVICE DESCRIPTION LANGUAGE

(76) Inventor: Christophe Boulange, La Garenne Colombes (FR)

Correspondence Address: HOFFMAN, WARNICK & D'ALESSANDRO LLC, 75 STATE ST, 14 FL, ALBANY, NY, 12207, US

(21) Appl. No.: 11/942,247

(22) Filed: Nov. 19, 2007

(30) Foreign Application Priority Data
Dec. 15, 2006 (EP) 06301261.1

(51) Int. Cl. G06F 9/30

(52) U.S. Cl. 712/200; 712/E09.016

(57) ABSTRACT

A method, system, and computer program product for providing a response to a user instruction in accordance with a process specified in a high level service description language. A method in accordance with an embodiment of the present invention includes: receiving at a multimodal engine a user instruction using one of at least two available modalities; transmitting the user instruction from the multimodal engine to a high level service description execution engine; executing the high level service description language with the high level service description execution engine to determine a response to the user instruction; and providing the response to the user through the multimodal engine.

### FIELD OF THE INVENTION

The present invention is directed to the rendering of computer based services to a user and, more particularly, to a method, system and computer program product for providing a response to a user instruction in accordance with a process specified in a high level service description language.

### BACKGROUND ART

High Level Service Description languages are known, and Business Process Execution Language (hereafter “BPEL”) is perhaps the best known example. BPEL is used by service providers to specify services in terms of high-level state transition interactions of a process and, in particular, the type of long-running asynchronous processes that one typically sees in business processes. Such a high level of abstraction (occasionally termed “programming in the large”) includes terms describing publicly observable behaviors such as when to wait for messages, when to send messages, when to compensate for failed transactions, etc.

In addition, extensions to BPEL exist, which enable lower level specification of short-lived programmatic behavior, often executed as a single transaction and involving access to local logic and resources such as files, databases, etc. (occasionally termed “programming in the small”). For the avoidance of doubt, High Level Service Description hereafter refers to such “programming in the large” irrespective of extensions which may enable “programming in the small”.

Multimodal interaction is known and provides a user with multiple modes of interfacing with a system beyond the traditional keyboard and mouse input/output. The most common such interface combines a visual modality (e.g., a display, keyboard, and mouse) with a voice modality (speech recognition for input, speech synthesis and recorded audio for output).

Multichannel access is also known and is the ability to access data and applications from multiple methods or channels such as a telephone, laptop or PDA. For example, a user may access his or her bank account balances on the Web using a web browser when in the office or at home and may access the same information over a regular telephone using voice recognition and text-to-speech or WAP (Wireless Application Protocol) when on the road.

Multimodal access is the ability to combine multiple modes of interaction and/or multiple channels in the same session. For example, in a web browser on a PDA, one might select items by tapping or by providing spoken input. Similarly, one might use voice or a stylus to enter information into a field. To facilitate this, IBM with collaborators have created a multimodal markup language standard called XHTML+Voice (X+V for short) that provides a way to create multimodal Web applications (i.e. Web applications that offer both a voice and visual interface).

Multimodal interfaces are typically quite to very complex, not normalized, sometimes managed at the runtime in a device stack or in the server stack, and generally require deep knowledge of the modes of interaction to create or develop such a multimodal interface.

### SUMMARY OF THE INVENTION

The present invention is directed to the method, system and computer program product of providing a response to a user instruction in accordance with a process specified in a high level service description language. A method in accordance with an embodiment of the present invention comprises: receiving at a multimodal engine a user instruction using one of at least two available modalities; transmitting the user instruction from the multimodal engine to a high level service description execution engine; executing the high level service description language with the high level service description execution engine to determine a response to the user instruction; and providing the response to the user through the multimodal engine.

The method may further comprise transmitting modality information between the multimodal engine and the high level service description execution engine, wherein the operation of the engine receiving the modality information is modified in accordance with the modality information.

The present invention enables a service provider to specify in a high level service description language options for rendering a service based on modality in a way which separates the service creation from the management of the multimodal interaction. In other words, in a way which avoids the service provider having to create or extensively develop, configure, or program the multimodal engine. This in turn enables rapid service creation and development. The modality information may be transmitted from the multimodal engine to the high level service description execution engine and may, for example, describe a modality or modalities which are either available or used at the multimodal engine or specified to the multimodal engine by the user. The execution engine may then determine a response to the user instruction which is tailored to such a modality or modalities.

Alternatively, modality information specifying a preferred modality or modalities for output of the response to the user by the multimodal engine may be transmitted from the high level service description execution engine to the multimodal engine. This option can be specified by a service provider in high level service description language.

### BRIEF DESCRIPTION OF THE DRAWINGS

Reference will now be made, by way of example, to the accompanying drawings.

FIG. 1 illustrates a system having a BPEL execution engine in combination with an open multimodal engine capable of operating in accordance with the present invention.

FIGS. 2 to 4 are flow charts illustrating operation of the system of FIG. 1 in accordance with the present invention.

### DETAILED DESCRIPTION OF THE INVENTION

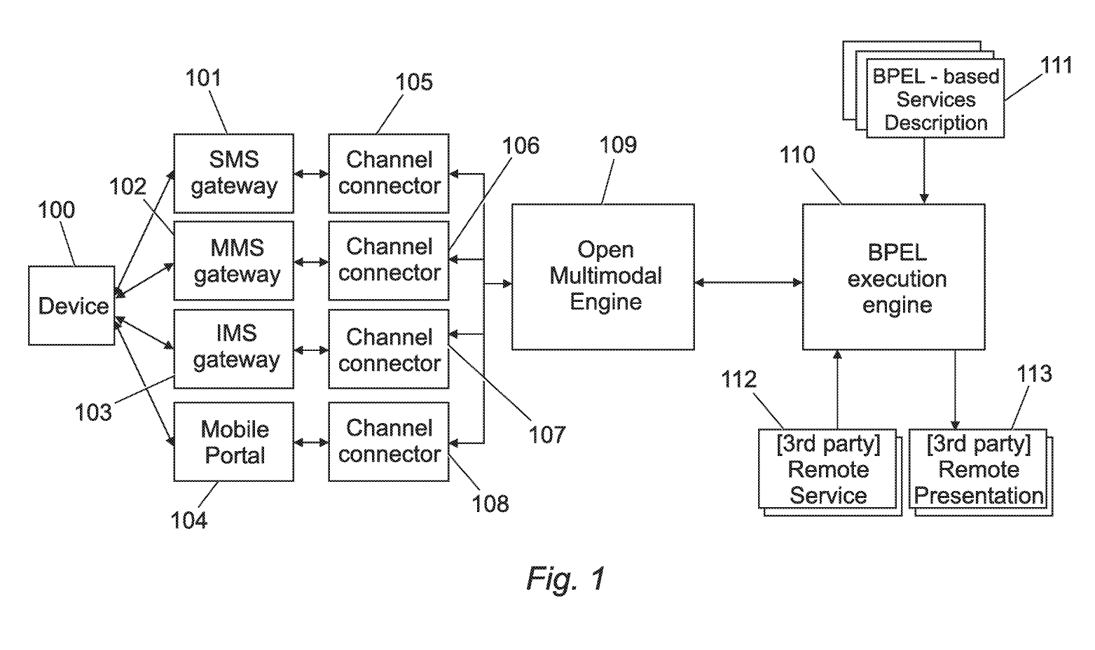

FIG. 1 illustrates a system having a BPEL execution engine in combination with an open multimodal engine (OME) capable of operating in accordance with the present invention. Specifically, a device 100 in the form of a mobile telephone operated by a user (not shown) has multimodal access to a computer based service using any one of four available, modalities: through a Short Messaging Service (SMS) gateway 101, through an Multi-media Messaging Service (MMS) gateway 102, through an Instant Messaging Service (IP Multimedia Subsystem) gateway 103, and a through a mobile portal 104 (i.e., web browser), all via respective channel connectors 105, 106, 107 & 108 to the OME 109. In physical terms, the OME 109 is a computer system belonging to the telephone network provider.

The service is specified in BPEL 111 and executed on a corresponding BPEL execution engine 110 which, in physical terms, is a computer system belonging to an information service provider. In addition to rendering services directly to the user through the OME 109, the BPEL execution engine 110 renders 113 and receives 112 third party services.

Such a system may be used, in accordance with the present invention, as illustrated in the following examples.

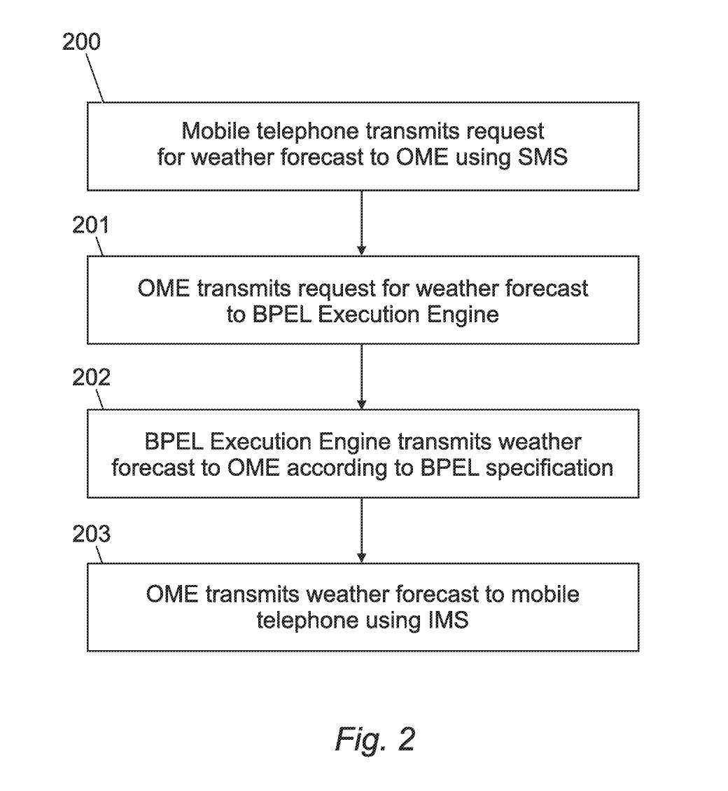

A first example is illustrated with reference to the flowchart of FIG. 2. Suppose a user of mobile telephone 100 wishes to obtain weather forecasts for Paris for the next five days. The telephone provides the user with four modalities with which to access remote information services: SMS, MMS, IMS and a mobile portal.

The user of the mobile telephone 100 sends an SMS request to the OME 109 for the weather forecasts (200). This request is fielded by the OME 109 and the OME 109 transmits a corresponding request for such weather forecasts to the BPEL execution engine 110 (201), selected by the OME 109 on the basis of being suitable to process such a request. Had the request by the user been presented to the OME 109 by another modality such as IMS, the same corresponding request would be transmitted by the OME 109 to the BPEL execution engine 110.

Up to date weather forecast information is periodically provided by a third party 112 such as a local metrological office to the BPEL execution engine 110. In practice, this could be done in advance of the user's request rather than in real-time pursuant to a specific user request.

In response to the request for weather forecasts and as specified in a BPEL service description 111, the BPEL execution engine 110 periodically sends to the OME 109 over the following five days a text description of the weather forecast for Paris, valid for the following few hours (202).

Upon receiving a periodic weather report, the OME 109 transmits to the mobile telephone 100 a computer generated voice message of the weather report by the IMS (203).

The modality that the OME 109 provides the weather forecast to the mobile telephone 100 can be determined on the basis of pre-defined user preferences provided by the user via mobile telephone to the OME 109 in a previous session. For example, the cost of receiving data typically varies depending on whether the mobile telephone is registered with a domestic telephone network or is roaming. Therefore, one might seek to avoid receiving large amounts of data and hence prefer to receive SMS messages rather than a corresponding computer generated voice message sent by IMS.

In the first example, the modalities available or used at the OME 109 or specified as preferred by the user to the OME 109 are not known by the BPEL Execution Engine 110. This has the disadvantage that for a particular service rendered by the BPEL execution engine 110, the BPEL execution engine 110 might have to respond to the OME 109 in a variety of media formats, e.g., scaleable images, voice data, and abbreviated text data, to ensure that the OME 109 is able to output to the mobile telephone a response in a format suitable for at least one of the available or preferred modalities.

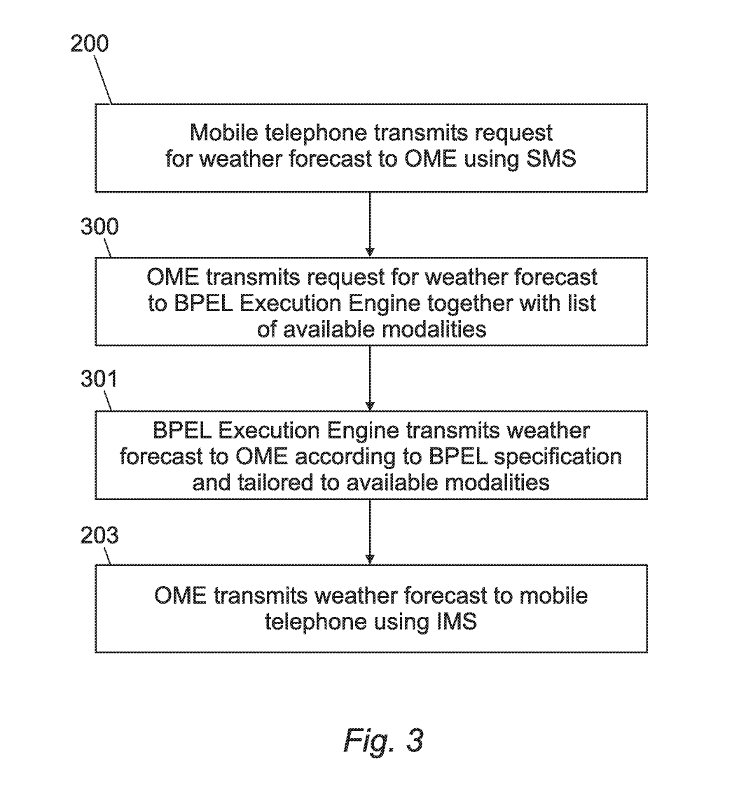

A second example of use of the system of FIG. 1, modified from the first example described above, is illustrated with reference to the flowchart of FIG. 3.

In this example, after a user has requested the weather forecasts by SMS (200), the OME 109 transmits a corresponding request for such weather forecasts to the BPEL execution engine 110 but, additionally, includes with the request a list of the preferred or available modalities (e.g., SMS, MMS, and IMS) as specified by the user to the OME 109 (300).

This enables the BPEL execution engine 110 to determine a response to the user's request which is tailored to those preferred or available modalities. In this case, the user prefers to use SMS, MMS or IMS and not the mobile portal.

Hence, if the BPEL execution engine 110 can respond with a high resolution JPEG image (of several hundred kilobytes of data) showing a satellite image of the weather over France, that image can be omitted in favor of a lower resolution image suitable, for example, for an MMS message or a textual description of the weather (301). This results in a bandwidth savings.

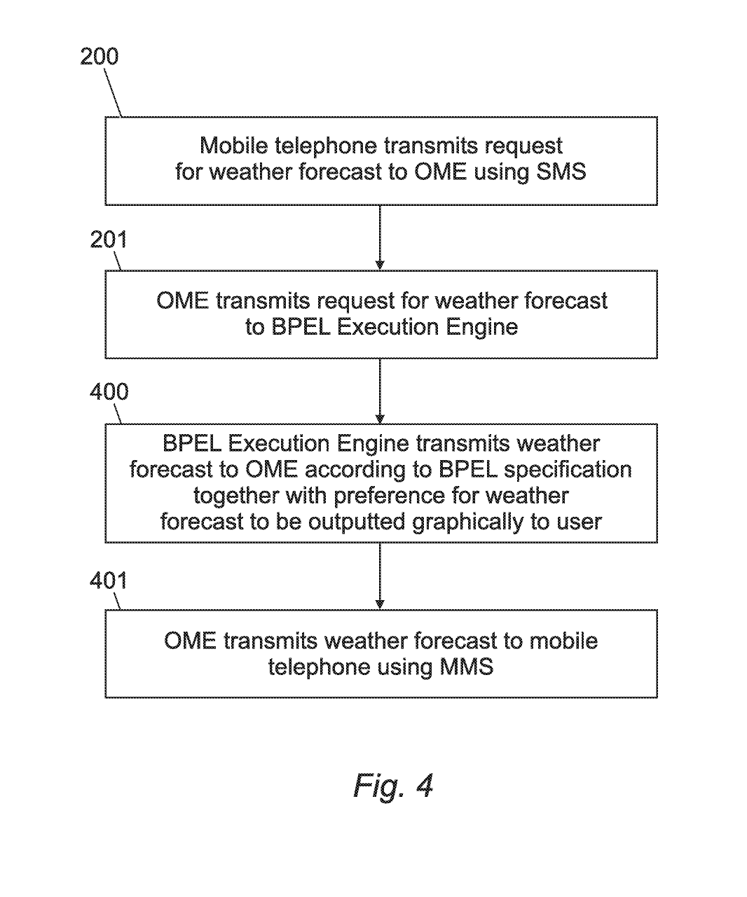

A third example of use of the system of FIG. 1, again modified from the first example described above, is illustrated with reference to the flowchart of FIG. 4.

After (200) and (201) as described above, the BPEL execution engine 110 transmits weather forecast information to the OME 109 together with a preference that the weather forecast information is outputted graphically to the user (400). The weather forecast information is provided from the BPEL execution engine 110 to the OME 109 in a scaleable JPEG image illustrating the Paris weather together with a corresponding text description.

Thereafter, and notwithstanding the user's preference for voice messaging, the OME 109 provides the weather report to the user graphically, using IMS (being preferred by the user over the mobile portal) (401). This enables the weather forecast provider to control how the weather forecast is rendered to the user. In the above example, this would be particularly useful if the image contained embedded advertising which resulted in revenue for the weather forecast provider. Only in the event that the user does not have an available graphical modality is the text description of the weather sent.

While the invention has been particularly shown and described with reference to various embodiment(s), it will be understood that various changes in form and detail may be made therein without departing from the spirit, and scope of the invention.

What is claimed is:

1. A method of providing a response to a user instruction in accordance with a process specified in a high level service description language, comprising:
receiving at a multimodal engine a user instruction using one of at least two available modalities;
transmitting the user instruction from the multimodal engine to a high level service description execution engine;
executing the high level service description language with the high level service description execution engine to determine a response to the user instruction; and
providing the response to the user through the multimodal engine.

2. The method of claim 1, further comprising:
transmitting modality information between the multimodal engine and the high level service description execution engine, wherein the operation of the engine receiving the modality information is modified in accordance with the modality information.

3. The method of claim 2, wherein the modality information is transmitted from the multimodal engine to the high level service description execution engine.

4. The method of claim 3, wherein the modality information describes a modality or modalities which are either available or used at the multimodal engine or specified to the multimodal engine by the user.

5. The method of claim 4, wherein the high level service description execution engine determines a response to the user instruction which is tailored to the modality or modalities which are either available or used at the multimodal engine or specified to the multimodal engine by the user.

6. The method of claim 2, wherein the modality information is transmitted from the high level service description execution engine to the multimodal engine.

7. The method of claim 6, wherein the modality information specifies a preferred modality or modalities for output by the multimodal engine of the response to the user.

8. The method of claim 6, wherein the modality information is specified by a service provider in high level service description language to the high level service description execution engine.

9. A system of providing a response to a user instruction in accordance with a process specified in a high level service description language, comprising:
a system for receiving at a multimodal engine a user instruction using one of at least two available modalities;
a system for transmitting the user instruction from the multimodal engine to a high level service description execution engine;
a system for executing the high level service description language with the high level service description execution engine to determine a response to the user instruction; and
a system for providing the response to the user through the multimodal engine.

10. The system of claim 9, further comprising:
a system for transmitting modality information between the multimodal engine and the high level service description execution engine, wherein the operation of the engine receiving the modality information is modified in accordance with the modality information.

11. The system of claim 10, wherein the modality information is transmitted from the multimodal engine to the high level service description execution engine.

12. The system of claim 11, wherein the modality information describes a modality or modalities which are either available or used at the multimodal engine or specified to the multimodal engine by the user.

13. The system of claim 12, wherein the high level service description execution engine determines a response to the user instruction which is tailored to the modality or modalities which are either available or used at the multimodal engine or specified to the multimodal engine by the user.

14. The system of claim 10, wherein the modality information is transmitted from the high level service description execution engine to the multimodal engine.

15. The system of claim 14, wherein the modality information specifies a preferred modality or modalities for output by the multimodal engine of the response to the user.

16. The system of claim 14, wherein the modality information is specified by a service provider in high level service description language to the high level service description execution engine.

17. A program product stored on a computer readable medium, which when executed, provides a response to a user instruction in accordance with a process specified in a high level service description language, the computer readable medium comprising program code for:
receiving at a multimodal engine a user instruction using one of at least two available modalities;
transmitting the user instruction from the multimodal engine to a high level service description execution engine;
executing the high level service description language with the high level service description execution engine to determine a response to the user instruction; and
providing the response to the user through the multimodal engine.
